(19) United States
(12) Patent Application Publication
(10) Pub. No.: US 2010/0248704 A1
(43) Pub. Date: Sep. 30, 2010

(54) PROCESS AND DEVICE FOR THE ACQUISITION, TRANSMISSION, AND REPRODUCTION OF SOUND EVENTS FOR COMMUNICATION APPLICATIONS

(76) Inventor: Andreas Max Pavel, Lugano (CH)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/444,911

(22) PCT Filed: Oct. 10, 2007
(86) PCT No.: PCT/DE07/01805

§ 371 Date: Jun. 2, 2010

(30) Foreign Application Priority Data
Oct. 12, 2006 (DE) 10 2006 048 295.6

(51) Int. Cl. H04W 4/00; H04H 20/88

(52) U.S. Cl. 455/416; 381/2

(57) ABSTRACT

A process for the stereophonic acquisition, transmission, and reproduction of sound events for communication applications in telephony with headphones and microphones available for each participant which to each ear area of every participant is assigned a combination consisting of an earphone or a headphone as well as a microphone each, provided in close proximity one to the other in connection that has no acoustic echo or feedback, whereby the real, binaurally acquired environment, related to the head of the respective acquiring participant with respect to its reflection, diffraction, and resonance behavior is transmitted to each of the participants in the form of corresponding stereophonic sound and acoustic images via a two-channel connection.

### CROSS-REFERENCE TO RELATED APPLICATIONS

The present application is a national stage application under 35 U.S.C. §371 of International Application No. PCT/DE2007/001805, filed Oct. 10, 2007, which claims priority from German Application No. 10 2006 048 295.6, filed Oct. 12, 2006, the disclosures of which are hereby incorporated by reference herein.

### BACKGROUND OF THE INVENTION

1. Field of the Invention

The invention concerns a process and device for the stereophonic acquisition, transmission, and reproduction of sound events for communication applications in telephony, the process making use of headphones for each participant and making use of microphones.

2. Description of the Related Art

In the field of stereophonic remote transmission of sound events, stereophonically designed, real-time full-duplex transmission routes of high quality are common in the area of broadcast and recording studio technology, which, however, are tied to stationary network transfer points. In addition, stereophonic, short-range, wireless point-to-point connections of similar high quality are known, which are primarily utilized for broadcast interviews in the field.

In the field of telephonic conference calls, on the other hand, many proposals have already been made for the stereophonic acquisition, transmission, and reproduction of telephone signals, either for the better identification of the individual conversation partner(s) or to improve voice intelligibility or, in any case, in the way of a panorama mixing that positions each individual incoming monophonically captured source (speaking participant) in a different direction within the stereo panorama.

### BRIEF SUMMARY OF THE INVENTION

Neither today's technologies for stereophonic transmission in the field of radio and recording studios nor existing proposals for a stereophonic configuration of conference circuits deal with the core area of this invention—the mobile transmission of personal acoustic images in real time—because the field itself is new in that it addresses a new task or function.

However, to quote in some way comparable state of the art publications, one may refer to the following by way of example: WO 98/42161 A2, U.S. Pat. No. 4,088,849 A, EP 0 724 352 A2, DE 40 41 319 A1, EP 0 358 028 A2, JP 02217100 AA, DE 100 20 857 A1, JP 06268722 AA, DE 37 37 873 C2.

In WO 98/42161 A2, the telephonic transmission of a three-dimensional sound event occurs through two microphones arranged to be stationary in front of the participant(s), at a distance to one another, in connection with a personal computer, with the distance corresponding approximately to the width of a human head. Preferably, the microphones are arranged within artificial ear shapes, as the entire arrangement is supposed to resemble an artificial head, or at least to follow the principle of so-called separation-device stereophony (or Trennkörper-Stereophonie, a German term referring to stereophonic sound-capturing techniques that make use of two microphones separated by an acoustically opaque head-sized object). Loudspeakers are provided and arranged at a distance to one another on both sides for the reproduction of the stereophonic signals received in this manner from the respective opposite side, thus completing the arrangement. A multitude of special circuits for filtering, compressing, data reduction, and, possibly, cross-over compensation, is also used, in particular to compensate for the special distortions that result when a signal is first acquired by a dummy head or Trennkörper microphone arrangement and then comes to the respective listener via loudspeakers.

The device as described by WO 98/42161 A2 is basically to be considered user-neutral. It is therefore not geared towards a subjective person, as the present invention, which is explained in detail in the following, strives to do, in that the present invention transmits a conversation participant's subjective and thus personal listening image in accordance with the changing acoustic environment as it relates to that conversation participant. In contrast, in WO 98/42161 A2 the acoustic environment is always transmitted from the same perspective, which is captured, or “acquired”, by the rigidly mounted dummy head. For this reason, this known device behaves in a neutral manner with regard to all persons participating in the acoustic event. This situation may be desirable for a conference, since it permits each individual participant to be located in a different position and thus allows for the easy identification of each talking person, when the environment is acquired by the dummy head, under the condition that people do not move around during the conversation. WO 98/42161 A2 also mentions the possibility of using headphones for the reproduction of the incoming conference calls, as a purely accessory means, which can further improve the perceived location of the individual participants of an incoming conference. But this would make the internal communication of a group of listening participants that are using headphones in the same room rather difficult.

From the point of view of its basic conception and the very purpose that it fulfills, the presently claimed invention leads away from the arrangement disclosed in WO 98/42161 A2 in many ways and actually moves in the opposite direction:

1) the personal perspective which is the basis of the present invention, with its typical head and body movements, does not allow for a stable and reliable positioning of any conversation partner within the environment that is being acquired;
2) on the reproduction side, the voice of the actual wearer of a device based on the present invention, as acquired by his equipment and reproduced to a conversation partner at a different location, would be perceived outside of a potential conversation group assembled around the sender, namely, it would be perceived close to or within the head of the remote participant (in-the-head-localization).

Both conditions contradict the purpose of WO 98/42161 A2, which is to allow for a stable and predictable spatial distribution of individual conference participants, assembled around a table, from the perspective of a remote third party who is not physically present at the conversation. In addition

3) the battery-operated arrangement of the technical equipment worn on the body according to the characteristics of the claimed invention would not only be unnecessary for the object of WO 98/42161 A2, but it would even run contrary to its purpose or defeat it, which is to capture the unchanging spatial arrangement of a stationary conversation through the operation of a fixed telecommunication system installed in a conference room.

In order not to have to carry around an ordinary dummy head to make a binaural recording, especially in outside environments, U.S. Pat. No. 4,088,849 A utilizes the head of the recording person himself, by arranging artificial ear simulation shapes containing microphones on the outside of the monitoring headphones worn by him, while the left and right headphones are connected to one another by the usual flexible headband. The recording signals are fed into a tape recorder and played back through the headphones immediately thereafter in order to allow for the immediate monitoring of the sound event recordings. Thus, the wearer is his own “artificial head” with external simulation ears. The document does not make any allusion to a remote transmission of signals.

Another possibility for the identification of participants in a telephone conference call, where a stereophonic signal transmission is not taken into consideration, is shown in EP 0 724 352 A2. A digital telecommunication switching device includes a chart with the identification data of all participants. Whoever speaks the loudest is automatically put through and a corresponding identification is switched on in the devices of the other participants to indicate the speaking person.

In another context, namely in the field of system for video and audio communication systems, that are used, for instance, in long distance teaching via satellites, a deliberately operated microphone switching is already known as such as well—cf. DE 40 41 319 A1.

To improve voice recognition in the stereophonic remote transmission of sound events, it is known (JP 02217100 AA) to provide an additional frontal support microphone for voice mix-in whenever the voice of the speaker exceeds a preset threshold value (see abstract).

To improve the identification quality of conversation participants, reference is made to the possibility of simulating a stereophonic transmission (DE 37 37 873 C2) by processing the binaural signals provided to a listener through headphones or earphones with special filters (e.g. high passes, low passes, delay lines, all-pass filters and such) in order to add directional and distance information (which is known as binaural directional mixing). Through this, and by adjusting the filters according to the incoming calls from the various conversation participants, the voices can be assigned to different listening directions, which can significantly improve the intelligibility of the simultaneously incoming voices of various conversation participants, particularly in a noisy environment. In this way, such (virtually) “stereophonic” telephone connections are geared towards simulating a common “stereophonic space” to position mobile conversation participants or conference call participants, with the purpose of selectively assigning different directions to the simultaneously incoming voices of the individual conference participants.

DE 100 20 857 A1 points in a similar direction concerning the application of stereophonic simulation, though in this case to a mobile telecommunication unit with a micro record player, which, in simple terms, is as just a cell phone with MP3-Player. In this device headphones or earphones are provided as usual for the high-quality stereophonic enjoyment of music. In addition, at least one, preferably several, microphones are arranged in a so-called “head/auricle sound generating/clamping device”, which is also called a headset. The headset is separated from the mobile telephone unit and has a wireless connection. It is this wireless connection which provides the necessary stereophonic/two-channel analog-digital as well as digital-analog conversion for each transmission direction (see column 2, lines 20-30 resp. 39/41). These explanations evidently refer only to the well familiar “bluetooth” wireless connections between the actual device and the headphones and microphone of the headset. DE 100 20 857 A1 emphasizes what it sees as a particularly significant improvement in such mobile telephone units with MP3-Players, which is the combination of the MP3 cell phone with electromagnetic shielding means to control biological stress effects caused by excessive field intensities (column 1, lines 35-46). For this purpose it is proposed to arrange natural silicium sand or rose quartz into oblong copper/plastic pipes, placed within pipe systems made of layered iron sheet/copper sheet, thereby reducing the bodily stress effects of or reactions to “electro-smog” (columnl, lines 47-54).

DE 100 20 857 A is often rather ambiguous and lacking in clear instructions for technical action with the desirable and necessary clarity, but in any event measures that are needed for a real stereophonic telecommunications transmission are not envisioned in that publication; which only considers the above-mentioned Bluetooth transmission between the mobile telephone device and the speech capturing and listening headset that connects to it. This becomes clear, inter alia, from the reference in column 2, lines 54-59, according to which the various voice and audio signals reproduced to the user/listener may be individually mixed and direction-filtered binaurally for their selective placement of such signals in different listening directions. This direction filtering corresponds to the previously mentioned high pass/low pass and similar filters that adjust deliberately assigned listening source directions according to DE 37 37 873 C2; whereas, within a real life stereophonic panorama acquisition, the deliberate directional positioning of the reproduced sound sources is neither intended nor possible.

A multiplex receiver circuit is described in JP 06268722 AA, which splits the input signal received via the telephone line into a left and a right loudspeaker signal and processes it accordingly, especially for subscribers who are receiving high-quality musical products via a telephone connection.

Finally, a digital time-multiplexing telecommunication switching device can be derived from EP 0 358 028 A2 by using a voice memory that can be utilized as a conference memory and expanded by additional memory cells. Within that arrangement, a feedback loop connects the output of the voice memory to its input. Stereophonic aspects are not taken into consideration.

The present invention is conceived to fulfill the task of allowing for the transmission, and in particular for the mobile transmission, of personal three-dimensional listening images, in real time, through the medium of stereophonic telephony, adapted to this task or purpose as needed.

The invention solves this problem by the characteristic features of the main claim or of the first device claim and thereby establishes a new field: the transmission of personal listening images in real time.

Through the binaural capture—or binaural acquisition—of sounds at the ear area of each conversation participant, natural head-related listening images are produced which can be transmitted as a personal stereo panorama that corresponds to live reality in the greatest approximation. Each participant, through his respective headphones or earphones, perceives the environment where his conversation partner is currently located, as related to that partner's head, including that partner's voice as it is heard by that partner in his environment and only in that environment and thus, with all the reflections, diffractions, and resonances produced within that environment or influenced by it. This is also a major factor in providing for good voice intelligibility, since the precise circumstances are replicated which the voice-processing brain regions of every person are accustomed and have adapted to from the beginning of the evolution of language, namely, to perceive the full sound of a voice with the specific spectrum of resonances, diffractions and reflections generated within a particular environment in relation to a listener's own body, rather than the cut-down spectrum of the narrow and practically dead sound of the hitherto practiced telephonic voice transmissions.

Another phenomenon, that is actually part of this, is that the means of the invention effectively succeed in suppressing the perception of interfering noises because such noises can be well located by the listening participant and can therefore be selected, a priori, as not being part of the conversation. This, too, is a special ability of the human ear and brain—and presumably not only of the human ear or brain—and it shows actually very well in the so-called “cocktail party effect” that is often mentioned in this context: despite the actual noise mush resulting from the overlapping of multiple voices coming from different distances and directions, those present have practically no problem at all in distinguishing the individual speakers, even from some distance and in concentrating on the one they are interested in.

The perception of all other sound events of the same loudness and even of sound events that are still louder, is unknowingly suppressed or weakened to a level that no longer hinders understanding. By utilizing this natural phenomenon, the invention allows for a natural conversation that is immediately orientated to any particular conversation partner—also in conference situations of any kind—which is achieved by performing a binaural acquisition of the acoustic environment as it relates to the participant's head.

For a better understanding of exactly this aspect of the invention, it should be pointed out that a high-quality binaural transmission allows a conversation participant at the other end of a telephone connection to experience one's own local acoustic world from one's own person-related perspective, with all of its perceived sound colours, tone sequences and also spatial characteristics, as if it was a piece of “acoustic theatre”, whether one is in a New York jazz club, at the carnival in Rio, or at a beach with breaking waves and shrieking seagulls.

Within this perspective there is also the possibility of adding or mixing other sound or tone sequences into the transmitted binaural stereo signal that contains one's local sound and voice environment: for instance music or songs or whatever else is stored in the mobile phone that one is using or in one's digital music player, appropriately attenuated in its dynamics, so as not to interfere with the conversation. If the normally resulting “in-the-head-localization” of the added conventional audio signals is to be avoided, binaural directional encoding can be provided for this purpose. The integration of such diverse functions as a telephone, MP3-Player, game console, computer and the like, in a single small device, represents today's general state of the art and which can, of course, be part of any chosen embodiment of the present invention.

In spite of the relatively high demands made on wired or wireless data transfer by a broadband binaural full-duplex connection working in real time—be that via circuit-switching or package-switching network structures transmission quality adequate to the purpose of the invention can be achieved with the network bandwidths and quality of service available today, through the appropriate choice from the signal and channel coding and decoding processes and their potential implementations that are available today. The high-quality communication connections in the area of broadcast and studio technology mentioned above, which are realized via broadband wired network structures as well as via wireless point-to-point connections or with the aid of channel bundling processes in cellular phone networks, are highly developed examples showing that the technical prerequisites exist for the realization of the binaural communication in the sense of the present invention. Internet telephony, which is usually known as VoIP (Voice-over-Internet-Protocol), is a special application of the previously mentioned package-switched network structures that can be used in conjunction with existing wireless communication interfaces such as WiMax or its potential successors, such as HiperLAN/2, as part of the above-mentioned structures and processes which are suitable for the implementation of the envisaged binaural real-time communication with adequate quality of service.

Special advantages that considerably increase or exploit the practical potential of the present invention result in particular from the personal mobility provided by the measures cited in claim 2, through the transmission of live personal listening images which extend, in their mobile and person-related configuration, to the full variety of real life situations, instead of being restricted to the local environment of a fixed line connection or, in the case of a local wireless connection, to the very narrow reception area of such a connection.

It is just a mobile telephony of this kind that can be seen as the main or in any event the broadest potential application of binaural stereophony. Although this has never been publicly recognized, even after their inception, these two technologies are so to say made for each other, be it from the point of view of their technical configuration, be it from the point of view of their practical use. Through the integration of a mobile duplex connection in real time with a binaural transmission technology, the progressively emerging concept of a so-called telepresence, or teletransportation, can be implemented with great efficiency in the acoustic field.

With reference to the specific field of conference call technology which, however, does not represent the core area or the primary application of the claimed invention, the invention offers the advantage that for the first time both or—in the case of so-called conference calls (no matter whether they go from several participants in the same room to one or several participants located elsewhere, or whether they originate from several locations)—all participants are enabled to have conversations with every other participant in such a way that, in the case of mobile situations (be it that the speaking person changes location or that his sound environment changes because other persons join in), the continuously changing event sequences—in other words, that person's current listening perspective—are always transmitted in their full liveliness. The result is the impression that the listening conversation partner is, so to speak, in the same room with the speaker at the other end, subject to the same changing reflection and diffraction functions that normally occur in an active, live conversation with a counterpart in a certain environment, which is characterized not least by a desirable personal mobility, and to which one is naturally accustomed.

Due to this fact, but also because the distance of the binaurally receiving microphones to the mouth of the respective speaking person does not change, the dynamic relations remain unchanged, which means that the. volume does not have to be constantly adjusted, which helps to maintain the proper voice intelligibility that is of high quality as compared to the narrow-band, practically “mere voice” frequency transmission that is still practiced exclusively today and completely lacks the live quality of natural spaces and the multifaceted diffraction, resonance and reflection structures that are produced within the environment itself, as well as the complex overlaps generated by the human body, namely by the upper body, shoulders, head, etc., which are ultimately composed into the two-channel, stereophonic transmission function according to the invention.

The measures recited in the sub-claims describe advantageous developments and improvements of the stereophonic telephone connection as characterized in the main claim and in the first device claim.

### BRIEF DESCRIPTION OF THE DRAWINGS

Some embodiments of the invention are illustrated in the drawings and will be further explained in the following description. In the drawings:

FIG. 1 shows, in a schematic representation, a first embodiment of the present invention in the form of a stereophonic telephone connection with two participants in different locations; and

FIG. 2 shows a second embodiment of the invention, in which a first participant is connected via a stereophonic telephone connection with three other participants who are together in another location, in the manner of a conference call.

### DETAILED DESCRIPTION

The fundamental idea of the present invention is to convey the real environment of each conversation participant to the respective counterpart, in the form of personal three-dimensional head-related listening images, by means of a telecommunications connection, independently of whether the connection is made entirely via cable or completely or partially in a wireless way, particularly also during mobile transmission, with each participant disposing at least of a double microphone set to acquire binaural signals and of stereophonic headphones or earphones.

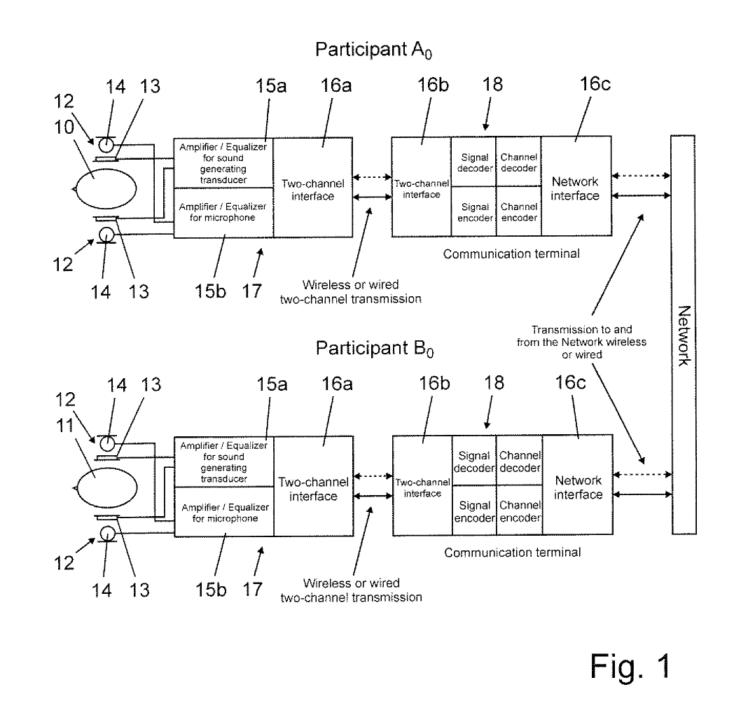

FIG. 1 shows what is meant. Participant Ao, whose head is indicated by 10, is connected via a stereophonic telephone link with participant Bo with head 11. Each participant Aₒ and Bₒ uses a combination 12 contiguously to each of his ears or inside each of his ears, but in any event within the ear area, each combination 12 consisting of a sound generating transducer, usually a headphone or earphone 13, and a microphone 14, and together the two combinations provide for stereophonic acquisition and also for the reproduction of sound events. The microphones 14 are thus positioned contiguously to or within the ear areas, so that, by working together stereophonically, they are able to acquire exactly the acoustic images, called head-related images, which in fact depict the actual acoustic environment of the participant. It is self-understood that care has to be taken that the connection between, or configuration of, the microphones with the neighbouring sound generating transducers (headphones or earphones) is made in a way or with means suitable to avoid echo and feedback, so that the respective conversation participant does not have his own voice retransmitted back to him. Such a mutual acoustic insulation between headphones or earphones and microphones which assures freedom from feedback can be performed routinely by the expert.

As mentioned, the sound generating transducers can be of various types, e.g. supra-aural headphones or, preferably, earphones, so that head-spanning support sets can be avoided. In any case, for the amplification and equalization of the acquired or reproduced signals the two microphones (which together form a stereo microphone) as well as the two sound generating transducers 13 are each followed by amplifier/equalizer circuits 15a for the sound generating transducers and 15b for the microphones, to which they are connected through bilateral two-channel interfaces 16a. If one understands the combinations 12 assigned to each participant as a first assembly, then the amplifier/equalizer circuits with assigned interface 16a form a second assembly 17, which is itself connected through a wired or wireless two-channel transmission to the subsequent communication device 18, which in turn insures the two-channel connection, againd wired or wirelessly, to the network.

Independently of whether external, namely supra-aural open or closed headphones, or in-the-ear-phones are utilized, head-related stereophonic telephony signals will always result, which in the case of earphones, to which the microphones are attached or otherwise assigned, will also benefit at least partially from the auricle as a reflection, diffraction, and resonance body, which further improves the naturalness of the outgoing signals.

Due to the considerable possibilities offered today, and predictably in the future as well, by the continuously progressing technical development with respect to the integration of components and to increasing miniaturization, a special advantage results from the utilization of earphones also for the reason that the miniaturized combinations 12 in this case can be realized respectively with one earphone and one microphone even without wired input leads and therefore differently from the illustrations in the drawings; with a common supply battery for the earphone and the microphone of each combination 12 and a common ultra-short-distance transmitter to the next assembly 17, a comfortable wearing quality is obtained. No wire connections are dangling around the head of the participant and with the exception of the combination of microphone and sound transducing generator lightly plugged into each ear there is no sensible discomfort. As any user of a portable MP3 player like the “iPod” knows, the earphones are usually particularly advantageous inasmuch as they resemble open headphones, that is, they do not isolate the user from his acoustic environment, thus facilitating any desired kind of communication.

Actually, the respective circuit blocks in the assemblies 12, 17, and 18 are self-explanatory, for the expert, from the legends in the drawing. The equalizing circuits are used for signal standardization, which may be necessary when the respective conversation participants work with different headsets, made of two wireless ear sets, each one consisting of a microphone and an earphone, in order to achieve a comparable signal quality between different headsets. This may also be of significance with regard to different positioning of the microphone, but also because of the desired freedom from feedback. In hat context, the equalizers provide for compensations that will ultimately deliver a standardized signal to the interface that connects to the communication terminal.

For the desired separation of the individual assemblies to be meaningful, the interfaces 16a, 16b, and 16c are required to have a correspondingly high-quality two-channel design. They are connected by wire or wirelessly, through electromagnetic waves, to the corresponding interfaces of the subsequent assembly.

As a matter of principle, it should be noted that the separation and allocation of the various constructive assemblies and/or circuit blocks made in the drawing primarily serve the purpose of providing a visual representation and thus a better understanding of the basic functions comprised by the invention. It is selfunderstood that, not least due to the ongoing technical progress or to a different purpose in the allocation of the various parts or their design, another grouping of the circuit blocks as well as differently designed and interconnected signal processing circuits may be realized and utilized.

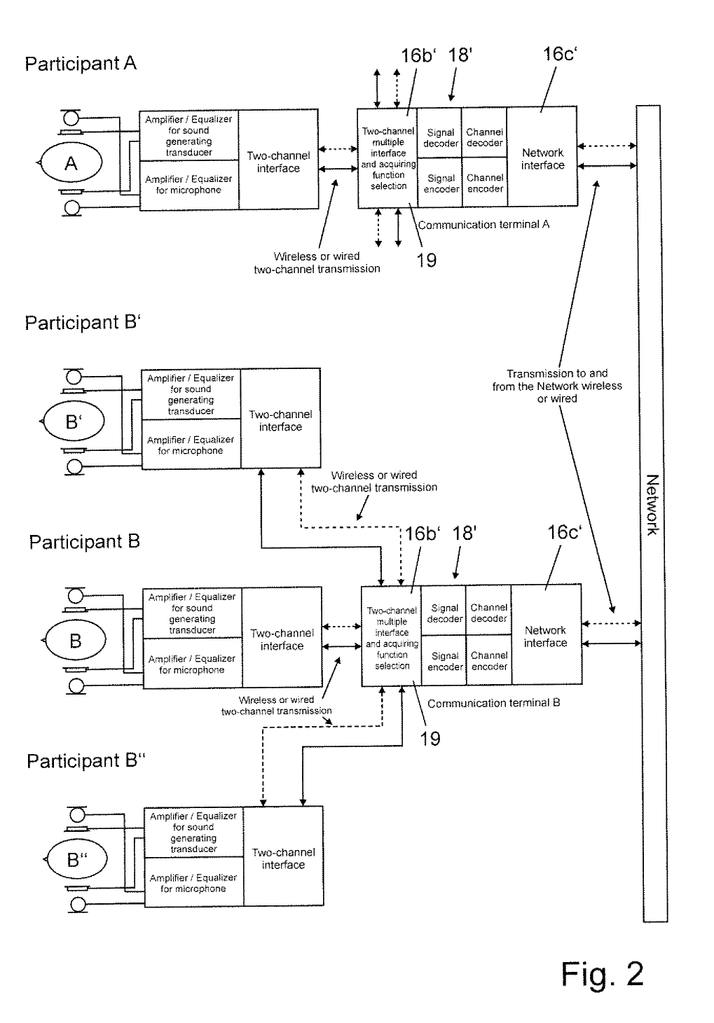

FIG. 2 depicts an advantageous embodiment of the invention in that at least on one side several participants B, B′, B″ exist who, in this case, are located at the same place, with each participant B, B′, B″ wearing a headset comprising a combination 12 which consists of microphone and a sound generating transducer for each ear, in the same way as conversation participant A, with whom each of the participants B, B′, B″ has a two-channel connection via the network. For this purpose, each of the participating communication terminals 18′ in FIG. 2—and further conference participants A′, A″ might be located in the area of the participant A as well—is modified in that an acquiring function selection circuit 19 is added to the two-channel multiple input interface 16b′. It serves the purpose, in a first variant, of automatically deciding which microphone pair of which conversation participant is to be switched to the output network interface 16c′ and is thus to be released for transmission via the network. This can occur, for instance, by evaluating the dynamics of the voice signals generated by the single participants B, B′, B″ at any given time or by determining which of the participants is speaking at all. The acquiring function selection circuit then blocks the microphone signal transmission from the other participants, but of course not the sound signal transmission to the sound generating transducers of the other participants.

Another possibility of this arrangement lies in that the voice and environment signals coming from the speaking participant are not only switched to his communication terminal for telephonic transmission, but also fed back electrically by the acquiring function selection circuit 19 contained in the terminal device 18′ and sent to the sound generating transducers of the other participants in the same room, even if these participants can also hear these voice signals directly through the air. Actually, it cannot be excluded that sound generating transducers are used which make direct hearing difficult or prevent hearing altogether due to insulation.

If, at some time, the talking participant of this group of three, namely for instance participant B, who is speaking at first and connected accordingly, stops speaking, and if another participant, perhaps B″, begins to speak, then the acquiring function selection circuit of communication device 18′ will automatically switch participant B″ to the network interface 16c′. However, this does not mean that participant A at the other end of the network would necessarily hear only the conference participant who is now switched on; indeed he will, of course, continue to hear the other participants, even if in a weaker form, depending on their respective environmental situation, via the stereo microphone of participant B″, so that in this case, too, the full stereo panorama of three-dimensional sound will result for participant A, practically as it would be if he was sharing the same environment with participants B, B′, B″

It is possible, in addition to or instead of the automatic lay-out of the switching function, to design it for manual operation, so that, for instance, a participant who wishes to speak can deliberately operate a switch at his disposal, by means of which he will be switched by the acquiring function selection circuit to the network. Keys for muting, if for instance a discreet short conversation is to be held, can also be arranged. It is also advantageous to arrange a control display, light emitting diodes, or similar means, in the area of the acquiring function circuit or in another appropriate location, to show which of the conversation participants is being switched by the acquiring selection circuit 19 to the output of network interface 16c′. Since the other switching components of the conference circuit variant of FIG. 2 correspond to the circuit blocks of FIG. 1, this does not need to be further discussed at this point. FIG. 2 also omits repeating the numbered reference signs of the circuit blocks that already have been discussed and depicted with their functions in FIG. 1.

With reference to the signal and channel decoders or encoders in the communication terminal, it should be added that the signal decoders and encoders perform digital/analog conversions and vice versa, as well as bandwidth determinations (the bandwidth of the signals may be at least 3.4 kHz or 8 kHz or 16 kHz). They also ensure the lowest possible group delay differences, while taking care not to change the coherence between the channels during the coding and decoding that adjusts the overall signal to the respective network, the actual stereo signals being already multiplexed, together with any auxiliary data, into a single signal at this point. Furthermore, these coders and decoders provide the required redundancy as well as error detection and correction. Ideally, the one-way running time including signal coding/decoding and transmission is to remain below 120 milliseconds, so that a timely signal transmission is assured without any interfering delays. Another advantageous embodiment of the invention should be mentioned as well, which consists in arranging an additional individual microphone preferably close to the mouth of each conversation participant, which either is mixed into the stereo signal as a type of support microphone—to further improve intelligibility, for instance—or, alternatively, may completely replace the stereo signal of the binaural microphone pair. However, in doing so, one returns to the field of conventional monophonic telephony, even though binaural headsets are being used; yet one could implement this possibility when, under certain circumstances, and possibly even from the start of a conversation, the binaural stereophonic transmission of environmental information is not relevant or not desired. This may occur for instance when in the course of a conversation such a monophonic operation is to be switched on for the expedient conveyance of vocal information, whereby the bandwidth of the signal transmission as well as the related costs can be reduced. Corresponding measures can be integrated into the existing configuration without any problem, supplemented by a simple switch operated on the participant's side.

It is understood that all of the characteristics recited in the description, in the ensuing claims, and in particular also in the accompanying drawings, can constitute the essence of this invention by themselves as well as in any number of combinations between them.

1. A process for the stereophonic acquisition, transmission, and reproduction of sound events for communication applications in telephony, the process making use of headphones for each participant and making use of microphones, characterized in that to each of the left and right ear areas of each participant a combination of an earphone or headphone and a microphone is allocated, the earphone or headphone and the microphone being arranged in close proximity to each other in a connection that is substantially free of acoustic feedback between the earphone or headphone and the microphone, whereby the real acoustic environment of each participant is acquired binaurally, in real time, and thus its relationship to the head of the respective participant is preserved in terms of reflection, diffraction and resonance behavior, and the acquired acoustic environment is transmitted to one or more other participants in the form of binaural stereophonic sound and listening images via a two-channel connection.

2. The process according to claim 1, characterized in that the double combination, consisting of said two single combinations assigned to the left and right ear respectively, is part of a mobile battery-operated telephonic receiver and transmitter attached to or used on the body of a person participating in the telephone traffic to transmit his respective head-related personal acoustic images.

3. The process according to claim 1, characterized in that, in the event of conference calls, every conversation participant in the same room is selectively switched into a local network connecting all conversation participants either by automatic switching, brought about by his personal conversation process, or by a deliberately operated change-over, through a circuit that selects the sound image acquisition of said participant.

4. The process according to claim 1, characterized in that in the case of several participants in the same room participating in a conference call, each of the participants not speaking at the moment will have at least the conversation signal electrically rooted to his binaural headphones or earphones through the communication device in addition to the natural acoustic room transmission.

5. The process according to claim 1, characterized in that each conversation participant can transmit tone and sound sequences (like music pieces or songs) that are stored in his respective stereophonic and possibly mobile telephone (like a cell phone with MP3 player) together with the stereophonic voice and environment transmission, if desired.

6. The process according to claim 5, characterized in that such added audio signals are submitted to binaural directional encoding in order to avoid the in-the-head-localization of such added signals when reproduced through headphones or earphones.

7. A device for performing the process of acquisition, transmission, and reproduction according to claim 1 characterized in that a combination (of a sound generating transducer and a microphone is provided for each left and right ear area of any conversation participant for the simultaneous binaural stereophonic acquisition, transmission, and reproduction of real life sound and listening images that preserve their relationship to the acquiring participant's head within his real environment in terms of their reflection, diffraction, and resonance behavior, where the sound generating transducer and microphone of each combination are arranged in close proximity to each other so as to avoid acoustic feedback and/or echo phenomena between the earphone or headphone and the microphone.

8. The device according to claim 7, characterized in that the double combination for binaural acquisition and reproduction, consisting of a combination of a sound generating transducer (headphone or earphone) and a microphone for each ear of the respective telecommunication participant, is part of a mobile telephonic battery-operated device worn by said respective participant.

9. The device according to claim 7, characterized in that two-channel amplifying/equalizing circuits as well as signal and channel encoder and decoder circuits are provided separately for the microphones and the sound generating transducers, respectively, for the further two-channel processing of the locally acquired and the received signals, respectively.

10. The device according to claim 7, characterized in that bilateral two-channel interfaces as well as a terminal interface are connected to or between the individual signal processing circuits in accordance to on their allocation to one another, with wireless or wired transmission between the bilateral interfaces or between the terminal interface and a network.

11. The device according to claim 7, characterized in that, in the event of several conversation participants in the same room, a two-channel multiple interface is provided to which the individual conversation participants are connected with the output signal of their respective personal signal processing, and that a reception-function selection circuit is provided for automatic or deliberate switching between binaural microphone signals received from one of the conversation participants to those received from another, for transmission into the network.

12. The device according to claim 7, characterized in that a first circuit group, consisting of the two ear area combinations, each comprising a microphone and a headphone or earphone, is connected to a second circuit group, consisting of amplifier/equalizer circuits for headphones or earphones and microphones, which in turn is connected to a communication terminal through bilateral wireless or wired two-channel interfaces, with the communication terminal comprising signal encoders and decoders as well as channel decoders and encoders and, in the case of multiple local conference participants, a multiple interface on the input side, to which a selection circuit, provided with control and monitoring displays, is added for the acquisition function, whereby the automatic or deliberate forward feeding of the output of any particular conversation participant into the telecommunications network is performed.

13. The device according to claim 7, characterized by a circuit configuration through which the stereophonic communication can be switched bilaterally to monophonic operation at any desired time.

14. The device according to claim 7, characterized by the inclusion of a third microphone in the vicinity of the respective participant's mouth for the mixing of a supportive voice signal into the transmitted stereo signal, if desired, or for allowing the monophonic operation.
